(19) United States
(12) Patent Application Publication
(10) Pub. No.: US 2025/0298556 A1
(43) Pub. Date: Sep. 25, 2025

(54) VALIDITY VERIFICATION METHOD FOR PRINT DATA AND PRINTING SYSTEM

(71) Applicant: SCREEN Holdings Co., Ltd., Kyoto (JP)

(72) Inventors: Atsushi IMAMURA, Kyoto-shi (JP); Koji MATSUO, Kyoto-shi (JP)

(21) Appl. No.: 19/036,113

(22) Filed: Jan. 24, 2025

(30) Foreign Application Priority Data
Mar. 21, 2024 (JP) 2024-044891

(51) Int. Cl. G06F 3/12; G06F 16/14

(52) U.S. Cl. CPC G06F 3/1208; G06F 3/1243; G06F 3/125; G06F 16/152

(57) ABSTRACT

On a PDF generation side, for each record, variable data of a used field is extracted from a variable data file, and a first hash value is calculated according to a predetermined calculation rule. Furthermore, on the PDF generation side, the variable data of the used field in the variable data file is placed on a corresponding page to generate a print data file. Thereafter, on an inspection side, the variable data is extracted from the print data file to calculate a second hash value according to the predetermined calculation rule, and whether or not the second hash value matches the first hash value calculated on the PDF generation side is inspected.

### BACKGROUND OF THE INVENTION

### Field of the Invention

The present invention relates to a validity verification method of verifying validity of data included in a print data file for variable printing.

### Description of Related Art

In recent years, variable printing for performing printing of different contents for each page on a predetermined format, such as printing of an invoice or direct mail, has been actively performed. When variable printing is performed, first, a template defining the content to be commonly printed for all pages, a placement position of variable data in which the print content (data value) may be different for each page, and the like is created by an operator. Then, a variable data file storing variable data for a plurality of records is prepared, and each variable data in the variable data file is placed on a page on the basis of a template, thereby generating a submitted data file for variable printing. Typically, a CSV file, which is a text data file in a format obtained by separating a plurality of pieces of text data by a comma (,), is employed as the variable data file.

Meanwhile, a PDF file (a file in a portable document format) may be adopted for submission of print data to a printing company. Submitting print data in the PDF file is called “PDF submission”. According to the PDF submission, it is possible to obtain an advantage that the possibility of occurrence of a trouble at the time of printing such as layout collapse can be reduced and an advantage that a size of submitted data can be reduced. Therefore, the PDF submission may also be adopted when the above-described variable printing is performed. Note that hereinafter, a PDF file as a submitted data file for the variable printing is referred to as a “variable PDF file”.

Generation of a variable PDF file will be described with reference to FIG. 26. Note that, here, a case where a CSV file is adopted as a variable data file, and an image is also placed on each page in addition to the variable data included in the CSV file will be described as an example. Furthermore, regarding the variable data file (CSV file), in the following description, a field named “Z” is referred to as a “Z field”. For example, a field named “address” is referred to as an “address field”.

With respect to FIG. 26, a variable data file 91 includes variable data for a plurality of records. Note that names of the respective fields are described in the first line. Each record includes a plurality of pieces of variable data such as a name and an address. Furthermore, in this example, three images 92 (1) to 92 (3) are prepared. Each record is associated with any one of the three images 92 (1) to 92 (3) by an image field of the variable data file 91. When a process of generating a variable PDF file 93 is started, first, the variable data of the first record (the record in which the data value of the number field is “1”) in the variable data file 91 is placed on page 1 based on a template, and the image 92 (1) is placed on page 1 based on the template and the data value of the image field of the first record in the variable data file 91. Next, the variable data of the second record (the record in which the data value of the number field is “2”) in the variable data file 91 is placed on page 2 based on the template, and the image 92 (3) is placed on page 2 based on the template and the data value of the image field of the second record in the variable data file 91. Thereafter, similar processing is repeated until the last record in the variable data file 91. As a result, the generation of the variable PDF file 93 ends. Note that, in FIG. 26, the contents of the variable PDF file 93 is schematically illustrated.

A variable PDF file is generated as described above. Since personal information is printed in variable printing, it is important to verify the validity of the contents of the variable PDF file. This is because it is necessary to prevent occurrence of an unacceptable event such as sending of a printed matter on which personal information of a certain person is printed to another person or sending of an invoice on which an incorrect invoice amount is printed to a customer. In the example of the variable PDF file 93 illustrated in FIG. 26, as illustrated in FIG. 27, it is necessary to verify whether the name is correctly printed (see an arrow denoted by reference sign 95), whether the address is correctly printed (see an arrow denoted by reference sign 96), and whether the image is correctly printed (see an arrow denoted by reference sign 97).

Three conventional techniques (first to third conventional techniques) for verifying validity of contents of a variable PDF file will be described below. Note that the first conventional technique and the second conventional technique are often used in combination.

The first conventional technique is a technique using a barcode. In this technique, when a variable PDF file is generated, variable data to be placed on each page is barcoded, and the barcode is embedded in the variable PDF file. Then, at the time of verification, the data value obtained by decoding the barcode embedded in the variable PDF file is compared with the data value included in the variable data file that is a generation source of the variable PDF file. Note that a QR code (registered trademark in Japan) may be used instead of the barcode.

The second conventional technique is a visual technique. In this technique, the contents of the variable PDF file and the contents of the variable data file that is a generation source of the variable PDF file are displayed on a display unit of a computer and are visually compared. Note that, in some cases, one of them is printed and the printed matter is visually compared with the screen of the display unit, or both of them are printed and the printed matters are visually compared.

The third conventional technique is a technique of extracting variable data (typically, a character string) from a variable PDF file. In this technique, variable data placed on each page in the variable PDF file is extracted, and a data value of the extracted variable data is compared with a data value included in a variable data file that is a generation source of the variable PDF file.

Note that, in connection with the present invention, Japanese Laid-Open Patent Publication No. 2013-156907 discloses an invention of a printing system capable of preventing creation of a printed matter unintended by a user when variable printing is performed. According to this invention, authentication information is added to variable data when variable print data is generated, and in the printing device, the authentication information is detected from the variable data and whether or not the variable data is proper data is determined based on the authentication information. Then, only in a case where it is determined that the variable data is proper data, printing based on combined data obtained by combining the variable data and format data is performed.

According to the first conventional technique and the third conventional technique, since the comparison between the variable data (typically, the character strings) is performed without depending on layout information, it is not possible to detect, for example, an error that the telephone number is placed at a position where the address is to be placed (that is, column deviation of the CSV file as the variable data file). According to the second conventional technique, there is a concern that a verification time becomes long and omission of detection of an error occurs. Furthermore, in any of the first to third conventional techniques, a variable data file that is a generation source of the variable PDF file is required when verifying the validity of the contents of the variable PDF file. Since the variable data file includes personal information, a security risk such as leakage of the personal information increases. Thus, according to the conventional techniques (the first to third conventional techniques), the security risk increases due to the necessity of personal information for verification. Note that, according to the invention disclosed in Japanese Laid-Open Patent Publication No. 2013-156907, personal information is not required when determining whether or not the variable data is proper data, but it is not guaranteed that a data value of each variable data included in variable print data matches a data value of corresponding data of a generation source of the variable print data. That is, the validity of the content of each variable data is not guaranteed.

### SUMMARY OF THE INVENTION

Therefore, an object of the present invention is to verify validity of content of each variable data included in a print data file (typically, a variable PDF file) for variable printing without using personal information after the print data file is generated using the personal information.

One aspect of the present invention is directed to a validity verification method of verifying, by using a computer, validity of data included in a print data file for executing variable printing based on variable data having a data value that can be different for each page and fixed data common to all pages, the validity verification method including:
performing first hash value calculation processing of, for each of a plurality of records, extracting the variable data for a used field that is a field used for variable printing from a variable data aggregate that stores the variable data, and calculating a first hash value according to a predetermined calculation rule by using extracted variable data;
performing print data file generation processing of placing, for each of the plurality of records, the variable data for the used field in the variable data aggregate on a corresponding page based on layout information in which a name of a field and coordinates are associated with each other, and generating the print data file including information of the variable data placed on each page; and
performing print data file inspection processing of, for each of the plurality of records, extracting the variable data from the print data file based on information of the used field and the layout information, calculating a second hash value according to the predetermined calculation rule by using extracted variable data, and inspecting whether or not the second hash value matches the first hash value,
wherein the print data file inspection processing is executed by a second computer different from a first computer that executes the first hash value calculation processing and the print data file generation processing.

According to such a configuration, in the first computer, the first hash value is calculated according to the predetermined calculation rule using the variable data for the used field in the variable data aggregate (for example, a text data file or a database). Furthermore, in the first computer, the print data file including information of the variable data placed on each page is generated. Then, in the second computer, the second hash value is calculated, using the variable data extracted from the print data file generated by the first computer, according to the same calculation rule as the calculation rule when the first hash value is calculated. Moreover, in the second computer, whether or not the second hash value matches the first hash value calculated by the first computer is inspected for each of the plurality of records. Note that the data (the data value of the used field) of the generation source of the first hash value cannot be restored from the first hash value. Here, the variable data aggregate is not used for calculating the second hash value in the second computer. That is, personal information is not used to calculate the second hash value in the second computer. Furthermore, the variable data aggregate is not required for inspecting whether or not the second hash value matches the first hash value. Thus, the variable data aggregate is not required for the processing performed by the second computer to verify the validity of the content of each variable data included in the print data file. From the above, the validity of the content of each variable data included in the print data file can be verified without using the personal information after the print data file is generated using the personal information.

Another aspect of the present invention is directed to a validity verification method of verifying, by using a computer, validity of data included in a print data file for executing variable printing based on variable data having a data value that can be different for each page and fixed data common to all pages, the validity verification method including:
performing first checksum calculation processing of, for each of a plurality of records, extracting the variable data for a used field that is a field used for variable printing from a variable data aggregate that stores the variable data, and calculating a first checksum according to a predetermined calculation rule by using extracted variable data;
performing print data file generation processing of placing, for each of the plurality of records, the variable data for the used field in the variable data aggregate on a corresponding page based on layout information in which a name of a field and coordinates are associated with each other, and generating the print data file including information of the variable data placed on each page; and
performing print data file inspection processing of, for each of the plurality of records, extracting the variable data from the print data file based on information of the used field and the layout information, calculating a second checksum according to the predetermined calculation rule by using extracted variable data, and inspecting whether or not the second checksum matches the first checksum,
wherein the print data file inspection processing is executed by a second computer different from a first computer that executes the first checksum calculation processing and the print data file generation processing.

Still another aspect of the present invention is directed to a printing system capable of executing variable printing based on variable data having a data value that can be different for each page and fixed data common to all pages, the printing system including:
a first computer that performs first hash value calculation processing of, for each of a plurality of records, extracting the variable data for a used field that is a field used for variable printing from a variable data aggregate that stores the variable data, and calculating a first hash value according to a predetermined calculation rule by using extracted variable data, and print data file generation processing of placing, for each of the plurality of records, the variable data for the used field in the variable data aggregate on a corresponding page based on layout information in which a name of a field and coordinates are associated with each other, and generating print data file including information of the variable data placed on each page; and
a second computer that performs print data file inspection processing of, for each of the plurality of records, extracting the variable data from the print data file based on information of the used field and the layout information, calculating a second hash value according to the predetermined calculation rule by using extracted variable data, and inspecting whether or not the second hash value matches the first hash value.

These and other objects, features, modes, and advantageous effects of the present invention will become more apparent from the following detailed description of the present invention with reference to the accompanying drawings.

### BRIEF DESCRIPTION OF THE DRAWINGS

FIG. 1 is a block diagram illustrating an overall configuration of a printing system according to a first embodiment of the present invention;

FIG. 2 is a block diagram illustrating a hardware configuration of a computer that functions as a variable PDF generation device or a variable PDF inspection device in the first embodiment;

FIG. 3 is a diagram for explaining a functional configuration in the first embodiment;

FIG. 4 is a flowchart illustrating a schematic procedure of a series of processing related to verification of validity of print data in the first embodiment;

FIG. 5 is a diagram illustrating an example of a variable data file in the first embodiment;

FIG. 6 is a diagram schematically illustrating contents of a hash value file in the first embodiment;

FIG. 7 is a diagram illustrating an example of a print result when printing is performed based on a variable PDF file in the first embodiment;

FIG. 8 is a diagram illustrating an example of a template in the first embodiment;

FIG. 9 is a diagram for explaining a configuration of the variable PDF file in the first embodiment;

FIG. 10 is a flowchart illustrating a detailed procedure of first hash value calculation processing in the first embodiment;

FIG. 11 is a diagram for explaining sorting of used fields in the first embodiment;

FIG. 12 is a diagram for explaining character string combination in the first embodiment;

FIG. 13 is a flowchart illustrating a detailed procedure of variable PDF file generation processing in the first embodiment;

FIG. 14 is a block diagram for explaining details of a variable PDF inspection unit in the first embodiment;

FIG. 15 is a flowchart illustrating a detailed procedure of variable PDF file inspection processing in the first embodiment;

FIG. 16 is a diagram for explaining a functional configuration in a second embodiment of the present invention;

FIG. 17 is a diagram for explaining a configuration of a variable PDF file in the second embodiment;

FIG. 18 is a flowchart illustrating a schematic procedure of a series of processing related to verification of validity of print data in the second embodiment;

FIG. 19 is a flowchart illustrating a detailed procedure of variable PDF file generation processing in the second embodiment;

FIG. 20 is a block diagram for explaining details of a variable PDF inspection unit in the second embodiment;

FIG. 21 is a diagram schematically illustrating contents of a hash value file in a third modification;

FIG. 22 is a diagram illustrating an example of a print result when printing is performed based on a variable PDF file in a fourth modification;

FIG. 23 is a diagram illustrating an example of a variable data file in the fourth modification;

FIG. 24 is a diagram for explaining sorting of used fields in the fourth modification;

FIG. 25 is a diagram for explaining character string combination in the fourth modification;

FIG. 26 is a diagram for explaining generation of a variable PDF file in a conventional example; and

FIG. 27 is a diagram for explaining verification of validity of contents of the variable PDF file in the conventional example.

### DETAILED DESCRIPTION OF PREFERRED EMBODIMENTS

Hereinafter, embodiments of the present invention will be described with reference to the accompanying drawings. In a printing system according to each embodiment, variable printing based on variable data having a data value that can be different for each page and fixed data common to all pages is performed.

### 1. First Embodiment

### 1.1. Overall Configuration of Printing System

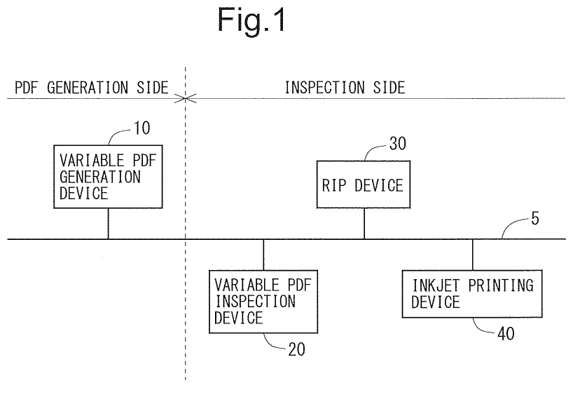

FIG. 1 is a block diagram illustrating an overall configuration of a printing system according to a first embodiment of the present invention. The printing system includes a variable PDF generation device 10 that generates a variable PDF file that is a print data file for variable printing and is a file in a portable document format, a variable PDF inspection device 20 that inspects (verifies) validity of data in the variable PDF file, an RIP device 30 that performs RIP processing on print data constituting the variable PDF file, and an inkjet printing device 40 that performs printing on the basis of print data subjected to the RIP processing by the RIP device 30. The variable PDF generation device 10, the variable PDF inspection device 20, the RIP device 30, and the inkjet printing device 40 are connected to each other by a LAN 5. Note that a first computer is implemented by the variable PDF generation device 10, and a second computer is implemented by the variable PDF inspection device 20.

Meanwhile, as described above, personal information is used in variable printing. Since the personal information is not allowed to leak to the outside, in this printing system, only a specific person can use the personal information. Specifically, the personal information can be used on a PDF generation side in FIG. 1, but the personal information cannot be used on an inspection side in FIG. 1. That is, the personal information can be used only in the variable PDF generation device 10.

Note that, although the variable PDF file generated by the variable PDF generation device 10 is transmitted to the variable PDF inspection device 20 via the LAN 5 in this printing system, the present invention is not limited thereto. For example, the configuration may be such that, after the variable PDF file generated by the variable PDF generation device 10 is stored in a file server via the LAN 5, the variable PDF inspection device 20 acquires the variable PDF file from the file server via the LAN 5. Furthermore, a configuration in which the variable PDF generation device 10 and the variable PDF inspection device 20 are not connected by the LAN 5 can be adopted, and in a case where this configuration is adopted, for example, the variable PDF file generated by the variable PDF generation device 10 can be given to the variable PDF inspection device 20 via a communication line (dedicated line, Internet, etc.) other than the LAN 5 or a computer-readable recording medium such as a DVD-ROM.

### 1.2 Hardware Configuration of Computer

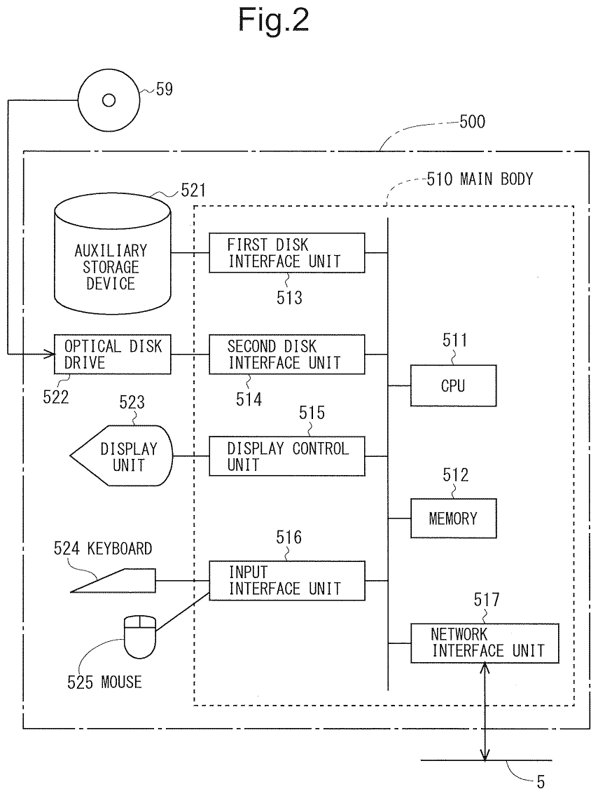

FIG. 2 is a block diagram illustrating a hardware configuration of a computer 500 that functions as the variable PDF generation device 10 or the variable PDF inspection device 20. The computer 500 illustrated in FIG. 2 includes a main body 510, an auxiliary storage device 521, an optical disk drive 522, a display unit 523, a keyboard 524, a mouse 525, and the like. The main body 510 includes a CPU 511, a memory 512, a first disk interface unit 513, a second disk interface unit 514, a display control unit 515, an input interface unit 516, and a network interface unit 517. The CPU 511, the memory 512, the first disk interface unit 513, the second disk interface unit 514, the display control unit 515, the input interface unit 516, and the network interface unit 517 are connected to each other via a system bus. The auxiliary storage device 521 is connected to the first disk interface unit 513. The auxiliary storage device 521 is a magnetic disk device or the like. The optical disk drive 522 is connected to the second disk interface unit 514. An optical disk 59 as a computer-readable recording medium such as a CD-ROM or a DVD-ROM is inserted into the optical disk drive 522. The display unit (display device) 523 is connected to the display control unit 515. The display unit 523 is a liquid crystal display or the like. The display unit 523 is used to display information desired by an operator. The keyboard 524 and the mouse 525 are connected to the input interface unit 516. The keyboard 524 and the mouse 525 are used by the operator to input instructions to the computer 500. The network interface unit 517 is connected to the LAN 5.

The auxiliary storage device 521 stores a program to be executed by the computer 500. The CPU 511 reads the program stored in the auxiliary storage device 521 into the memory 512 and executes the program, thereby implementing various functions. The memory 512 includes a RAM and a ROM. The memory 512 functions as a work area for the CPU 511 to execute the program stored in the auxiliary storage device 521. Note that the program is provided by being stored in, for example, the computer-readable recording medium (non-transitory recording medium). In the present embodiment, a variable PDF file generation program and a hash value calculation program are stored in the auxiliary storage device 521 of the computer 500 functioning as the variable PDF generation device 10, and a variable PDF file inspection program is stored in the auxiliary storage device 521 of the computer 500 functioning as the variable PDF inspection device 20. Processing realized by executing each of the variable PDF file generation program, the hash value calculation program, and the variable PDF file inspection program will be described later.

### 1.3 Validity Verification Method for Print Data

### 1.3.1 Outline

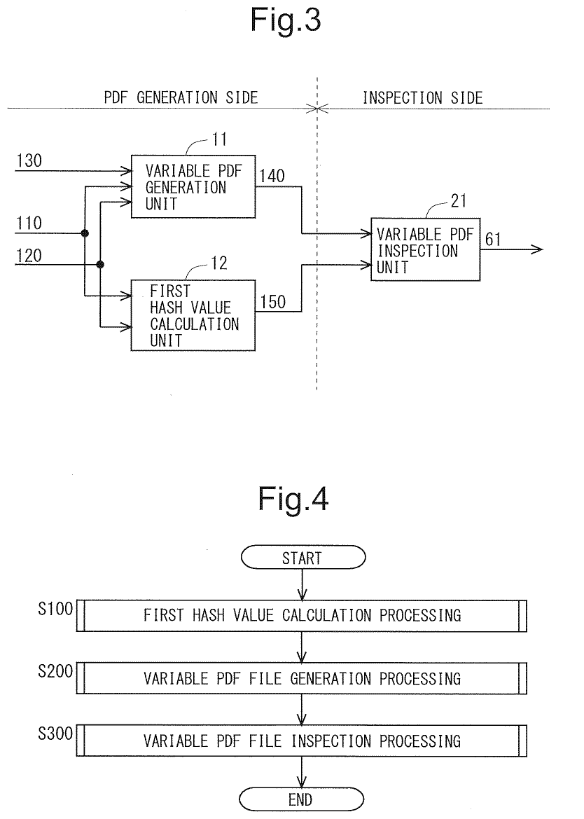

In this printing system, as illustrated in FIG. 3, as functional components related to verification of validity of print data, a variable PDF generation unit 11 and a first hash value calculation unit 12 are provided on the PDF generation side, and a variable PDF inspection unit 21 is provided on the inspection side. Hereinafter, a schematic procedure of a series of processing related to the verification of the validity of the print data will be described with reference to a flowchart illustrated in FIG. 4. Note that, in the present embodiment, it is assumed that a CSV file is employed as a variable data file that stores variable data for a plurality of records used for variable printing. Furthermore, in the present embodiment, it is assumed that a field for storing character data and a field for storing numerical data can be set as a used field (field used for variable printing among fields constituting a variable data file 110).

First, on the PDF generation side, the first hash value calculation unit 12 performs first hash value calculation processing (step S100). The first hash value calculation processing is processing realized by the CPU 511 in the computer 500 functioning as the variable PDF generation device 10 executing a hash value calculation program. For each of the plurality of records included in the variable data file 110 storing the variable data, the first hash value calculation unit 12 extracts the variable data for the used field in the variable data file 110 based on layout information 120 in which the names of the used fields and the coordinates on the page constituting a variable PDF file 140 are associated with each other, and calculates a hash value according to a predetermined calculation rule using the extracted variable data. There are various types of hash functions for calculating the hash value, and for example, secure hash algorithm 256 bit (SHA-256) can be adopted. Note that, for convenience, the hash value calculated by the first hash value calculation unit 12 is referred to as a “first hash value”. The first hash value calculation unit 12 also generates a hash value file 150 in which the first hash value calculated for each of the plurality of records and information of the used field are collected.

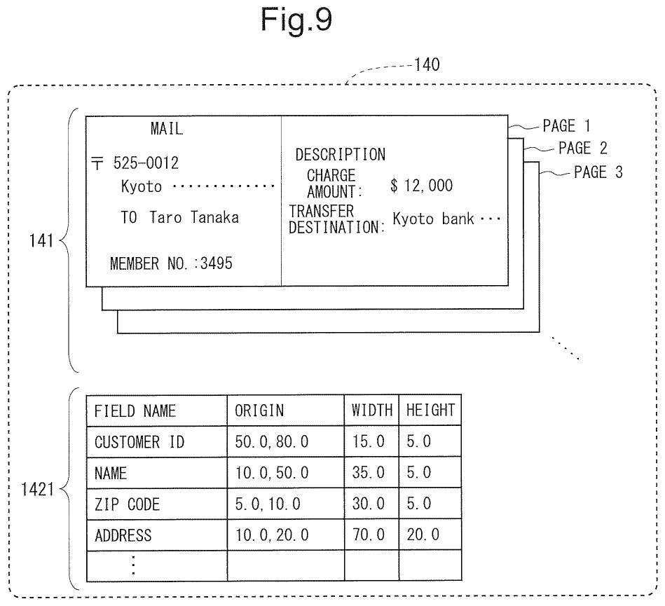

Next, on the PDF generation side, variable PDF file generation processing (print data file generation processing) is performed by the variable PDF generation unit 11 (step S200). The variable PDF file generation processing is processing implemented by the CPU 511 in the computer 500 functioning as the variable PDF generation device 10 executing the variable PDF file generation program. Based on the variable data file 110, the above-described layout information 120, and a template 130 that defines the content to be commonly printed in all pages and a placement position of the variable data, the variable PDF generation unit 11 places the variable data for the used fields in the variable data file 110 in a corresponding page for each of the plurality of records included in the variable data file 110, and generates the variable PDF file 140 as the print data file including the information of the variable data placed in each page. At that time, layout information is included in the variable PDF file 140 as metadata. Note that, for convenience, the layout information given to the variable PDF generation unit 11 and the first hash value calculation unit 12 is denoted by reference sign 120, whereas the layout information included in the variable PDF file 140 is denoted by reference sign 1421 (see FIG. 9).

In the above manner, the variable PDF file 140 and the hash value file 150 are generated on the PDF generation side. In the present embodiment, the variable PDF file 140 and the hash value file 150 are separately transmitted from the PDF generation side to the inspection side (transmitted from the variable PDF generation device 10 to the variable PDF inspection device 20).

Thereafter, on the inspection side, variable PDF file inspection processing (print data file inspection processing) is performed by the variable PDF inspection unit 21 (step S300). The variable PDF file inspection processing is processing realized by the CPU 511 in the computer 500 functioning as the variable PDF inspection device 20 executing the variable PDF file inspection program. For each of the plurality of records, the variable PDF inspection unit 21 extracts variable data from the variable PDF file 140 on the basis of the information of the used fields included in the hash value file 150 and the layout information 1421 included in the variable PDF file 140, and calculates a hash value according to a predetermined calculation rule using the extracted variable data. Note that, for convenience, the hash value calculated by the variable PDF inspection unit 21 is referred to as a “second hash value”. The variable PDF inspection unit 21 further inspects whether or not the second hash value matches the first hash value included in the hash value file 150 for each of the plurality of records, and outputs an inspection result 61.

Thus, the first hash value calculation processing and the variable PDF file generation processing are executed by the variable PDF generation device 10 on the PDF generation side, whereas the variable PDF file inspection processing is executed by the variable PDF inspection device 20 on the inspection side. That is, the variable PDF file inspection processing (processing of step S300) is executed by a computer different from a computer that executes the first hash value calculation processing (processing of step S100) and the variable PDF file generation processing (processing of step S200).

By the way, the calculation of the hash value (first hash value) by the first hash value calculation unit 12 and the calculation of the hash value (second hash value) by the variable PDF inspection unit 21 are performed according to the same calculation rule. Therefore, the validity of the content of each variable data included in the variable PDF file 140 can be verified by comparing the first hash value with the second hash value.

In the present embodiment, performing first hash value calculation processing is realized by step S100, performing print data file generation processing is realized by step S200, and performing print data file inspection processing is realized by step S300.

Note that, although the variable PDF file generation processing is performed after the first hash value calculation processing is performed in the present embodiment, the present invention is not limited thereto. The first hash value calculation processing may be performed after the variable PDF file generation processing is performed, or the first hash value calculation processing and the variable PDF file generation processing may be performed in parallel.

### 1.3.2 Files Used for Processing

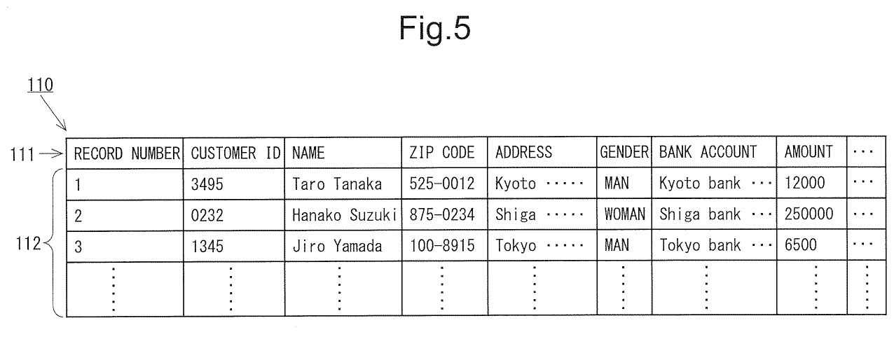

FIG. 5 is a diagram illustrating an example of the variable data file 110. As described above, in the present embodiment, the CSV file is adopted as the variable data file 110. Although the CSV file is a file in a format in which a plurality of pieces of text data are separated by commas (,), FIG. 5 illustrates display contents when contents of the CSV file (variable data file 110) are displayed using well-known spreadsheet software. In a row indicated by an arrow denoted by reference sign 111, a name of each field is described. For a portion denoted by reference sign 112, data of one row is one record. As illustrated in FIG. 5, the variable data file 110 used for variable printing stores a plurality of records each including a plurality of variable data. In the present embodiment, a variable data aggregate is realized by this variable data file 110.

Meanwhile, the variable data file 110 includes a large amount of personal information. In this regard, as described above, in the present embodiment, the personal information can be used only in the variable PDF generation device 10. That is, the variable data file 110 can be referred to from the variable PDF generation device 10, but the variable data file 110 cannot be referred to from the variable PDF inspection device 20. Such setting is performed.

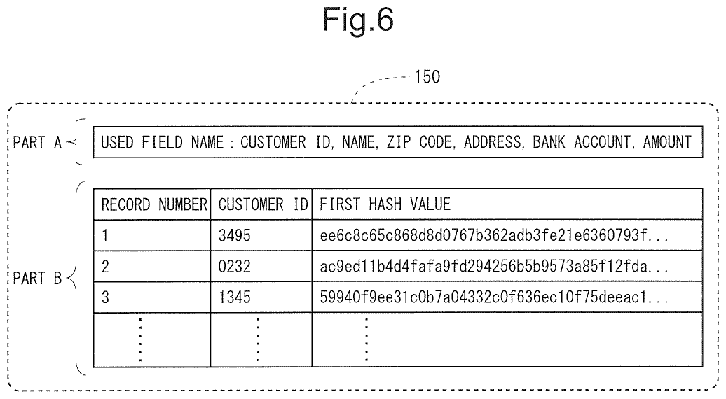

FIG. 6 is a diagram schematically illustrating contents of the hash value file 150. As illustrated in FIG. 6, the hash value file 150 includes information of used fields (refer to Part A) and information of a first hash value for each of a plurality of records (refer to Part B). The information of the used fields in the hash value file 150 illustrated in FIG. 6 represents that a hash value of a character string obtained by combining a data value of the customer ID field, a data value of the name field, a data value of the zip code field, a data value of the address field, a data value of the bank account field, and a data value of the amount field for each record is calculated as the first hash value.

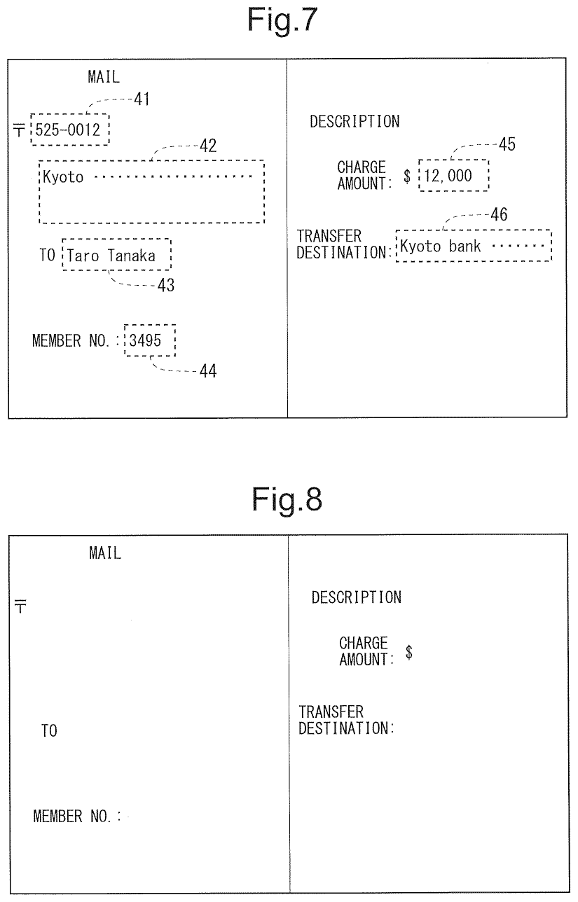

FIG. 7 is a diagram illustrating an example of a print result of the first record (that is, the print result of page 1) of the variable data file 110 illustrated in FIG. 5 when printing is performed on the basis of the variable PDF file 140. Note that the variable PDF file 140 is generated on the basis of the template 130 illustrated in FIG. 8. As illustrated in FIG. 7, on the page, the data value of the zip code field of the variable data file 110 is placed at a position denoted by reference sign 41, the data value of the address field of the variable data file 110 is placed at a position denoted by reference sign 42, the data value of the name field of the variable data file 110 is placed at a position denoted by reference sign 43, the data value of the customer ID field of the variable data file 110 is placed at a position denoted by reference sign 44, the data value of the amount field of the variable data file 110 is placed at a position denoted by reference sign 45, and the data value of the bank account field of the variable data file 110 is placed at a position denoted by reference sign 46. The variable data is placed at each position with reference to the layout information 120. Note that, although one record of the variable data file 110 corresponds to one page of the variable PDF file 140, one record of the variable data file 110 may correspond to a plurality of pages of the variable PDF file 140.

FIG. 9 is a diagram for explaining a configuration of the variable PDF file 140. The variable PDF file 140 includes actual data 141 that is actually displayed or printed, and metadata that is various types of information other than the actual data. In the present embodiment, the above-described layout information 1421 is included in the variable PDF file 140 as metadata. The layout information 1421 is information representing a placement position (more specifically, information on the coordinates, width, and height of the origin) on the page of the data value of each field of the variable data file 110.

### 1.3.3 First Hash Value Calculation Processing

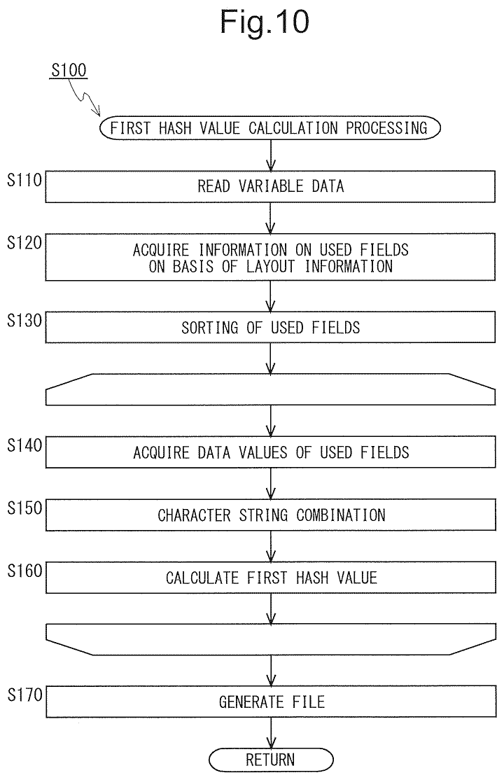

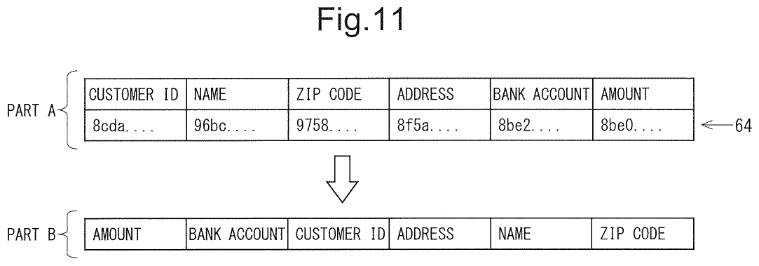

The first hash value calculation processing will be described in detail. FIG. 10 is a flowchart illustrating a detailed procedure of the first hash value calculation processing. After the first hash value calculation processing is started, first, variable data included in the variable data file 110 is read (step S110). In step S110, data of all fields is read. Next, information on the used fields is acquired on the basis of the layout information 120 (step S120). Regarding this, as described above, the layout information 120 is information in which the name of the used fields (fields used for variable printing) among the fields constituting the variable data file 110 and the coordinates on the page constituting the variable PDF file 140 are associated with each other. Therefore, the information of the used fields can be acquired from the layout information 120. After the information of the used fields is acquired, sorting of the used fields is performed (step S130). Specifically, processing of rearranging the plurality of fields specified in step S120 using the names of the fields as keys is performed. In this regard, in the present embodiment, the plurality of fields are rearranged in ascending order in the predetermined character code. For example, assuming that the arrangement order of the used fields in the variable data file 110 is as illustrated in Part A of FIG. 11 and the predetermined character code of each field is as shown in a portion indicated by an arrow denoted by reference sign 64, the arrangement order of the used fields after sorting is as illustrated in Part B of FIG. 11. Note that, although the used fields are sorted as described above in the present embodiment, the present invention is not limited thereto. If the arrangement order of the plurality of fields as used fields is uniquely determined, for example, the plurality of fields may be arranged in the order of appearance.

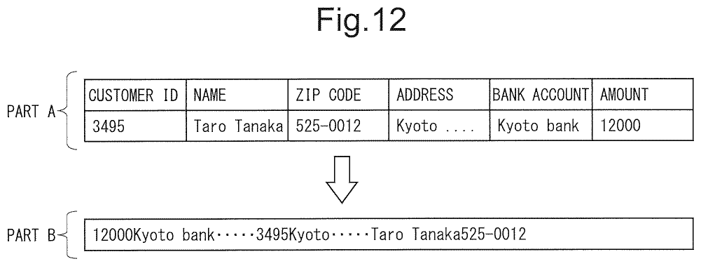

After the used fields are sorted, the processing of the following steps S140 to S160 is repeated the number of times equal to the number of records included in the variable data file 110. In step S140, for a record to be processed, data values of the plurality of fields as used fields are acquired from the variable data file 110 according to the arrangement order obtained in step S130. Next, a character string is generated by combining the plurality of data values (data values of the plurality of fields) acquired in step S140 (character string combination is performed) (step S150). In this regard, it is assumed that three fields (X field, Y field, and Z field) are used fields, and the sorted arrangement order of these three fields is “Y field, Z field, and X field”. In this case, when a data value of the X field is “ABC”, a data value of the Y field is “HIJK”, and a data value of the Z field is “123”, the character string generated in step S150 is “HIJK123ABC”. Therefore, for example, in a case where the data values of the plurality of fields as used fields with respect to the record to be processed are as illustrated in Part A of FIG. 12, a character string as illustrated in Part B of FIG. 12 is generated in step S150 (see also FIG. 11). After the character string is generated in this manner in step S150, a hash value of the character string is calculated as the first hash value (step S160). As above, the first hash value for each of the plurality of records included in the variable data file 110 is calculated.

After the processing of steps S140 to S160 is ended for all of the plurality of records included in the variable data file 110, the hash value file 150 including the information of the used fields and the information of the first hash value for each of the plurality of records is generated (step S170). As a result, the first hash value calculation processing ends.

Note that, as can be grasped from the above processing, in the present embodiment, the first hash value is calculated by the calculation rule of “calculating a hash value of a character string generated by combining data values of a plurality of fields as used fields in an arrangement order obtained by rearrangement using names of the fields as keys”.

In the present embodiment, reading the variable data is implemented by step S110, acquiring the information of the used field is implemented by step S120, performing rearrangement processing is implemented by step S130, performing character string generation processing is implemented by step S150, and calculating a hash value of the character string generated in the character string generation processing is implemented by step S160.

### 1.3.4 Variable PDF File Generation Processing

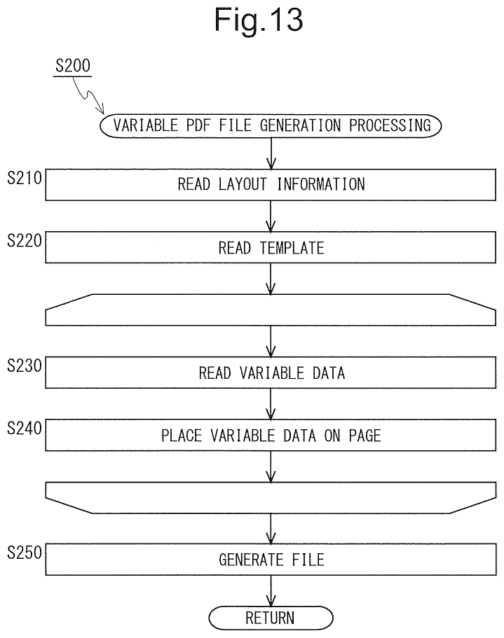

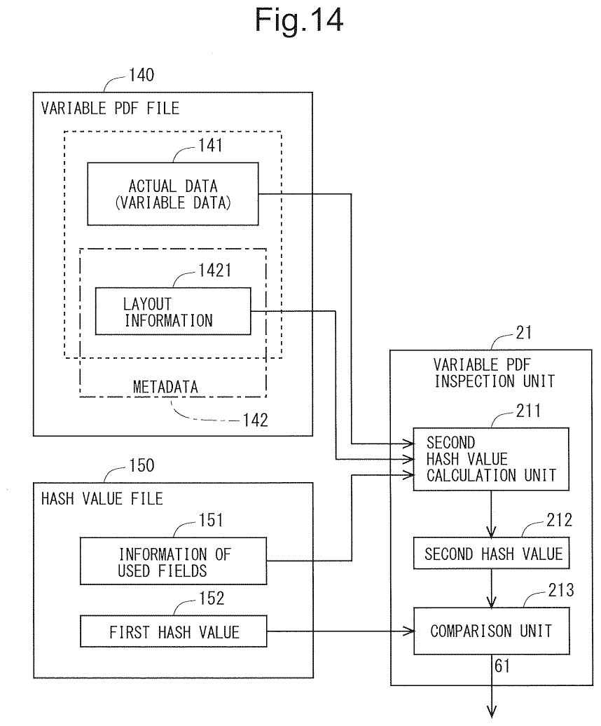

The variable PDF file generation processing will be described in detail. FIG. 13 is a flowchart illustrating a detailed procedure of the variable PDF file generation processing. After the variable PDF file generation processing is started, first, the layout information 120 is read (step S210). Next, the template 130, for example, as illustrated in FIG. 8 is read (step S220).

After the template 130 is read, the processing of the following steps S230 and S240 is repeated the number of times equal to the number of records included in the variable data file 110. In step S230, a plurality of pieces of variable data (data values of the plurality of fields as used fields) for a record to be processed is read from the variable data file 110. Then, in step S240, while referring to the layout information 120 read in step S210, the plurality of pieces of variable data read in step S230 is placed on the corresponding page on the basis of the template 130 read in step S220. That is, the variable data is placed on a page constituting the variable PDF file 140.

After the processing of steps S230 and S240 is ended for all the plurality of records included in the variable data file 110, the variable PDF file 140 is generated by adding the metadata including the layout information 1421 to the actual data 141 obtained by the processing of step S240 for the plurality of records (step S250). As a result, the variable PDF file generation processing ends.

### 1.3.5 Variable PDF File Inspection Processing

The variable PDF file inspection processing will be described in detail. FIG. 14 is a block diagram for explaining details of the variable PDF inspection unit 21 that performs the variable PDF file inspection processing. The variable PDF file 140 schematically illustrated in FIG. 9 and the hash value file 150 schematically illustrated in FIG. 6 are given to the variable PDF inspection unit 21. The variable PDF file 140 includes the actual data (variable data) 141 and metadata 142 including the layout information 1421. The hash value file 150 includes information 151 of used fields and first hash values 152.

The variable PDF inspection unit 21 includes a second hash value calculation unit 211 and a comparison unit 213. The second hash value calculation unit 211 acquires a data value of a position (position on the page) corresponding to each field of each record constituting the actual data 141 in the variable PDF file 140 on the basis of the layout information 1421. Then, for each record, the second hash value calculation unit 211 combines the data values of the plurality of fields on the basis of the information 151 of the used fields, and calculates a hash value of the character string obtained by the combination as a second hash value 212. The comparison unit 213 compares the first hash value 152 included in the hash value file 150 with the second hash value 212 calculated by the second hash value calculation unit 211 for each record, and outputs the inspection result 61.

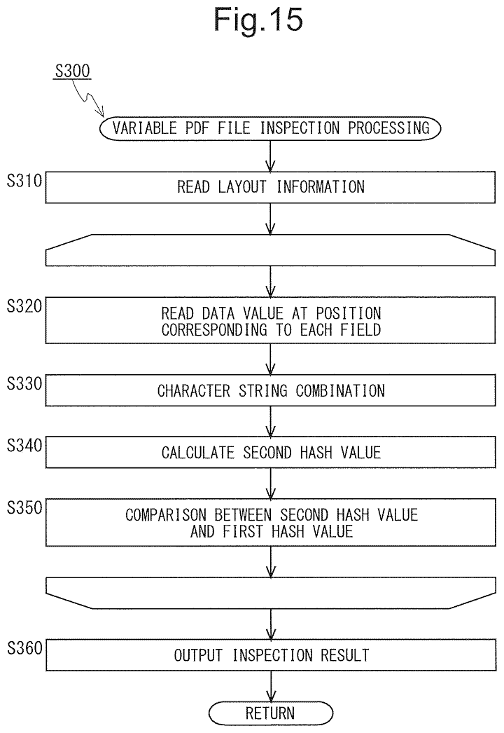

FIG. 15 is a flowchart illustrating a detailed procedure of the variable PDF file inspection processing. After the variable PDF file inspection processing is started, first, the layout information 1421 included in the variable PDF file 140 is read (step S310). Thereafter, the processing of the following steps S320 to S350 is repeated the number of times equal to the number of records of the actual data 141 included in the variable PDF file 140.

In step S320, for a record to be processed, the data value at the position corresponding to each field on the page constituting the variable PDF file 140 is read with reference to the layout information 1421. Since a plurality of fields are the used fields, a plurality of data values are read in step S320. Next, a character string is generated by combining the plurality of data values read in step S320 (character string combination is performed) (step S330). In step S330, by referring to the information 151 of the used fields, the data values of the plurality of fields are combined in the same order as when the character string is generated in the first hash value calculation processing (see FIG. 10). That is, the data values of the plurality of fields are combined in an arrangement order obtained by rearranging the plurality of fields using the names of the fields as keys. Thereafter, a hash value of the character string generated in step S330 is calculated as the second hash value 212 (step S340). Then, the second hash value 212 calculated in step S340 is compared with the first hash value 152 included in the hash value file 150 (step S350). In other words, for the record to be processed, it is inspected whether or not the second hash value 212 calculated in step S340 matches the first hash value 152 included in the hash value file 150.

After the processing of steps S320 to S350 is ended for all records, the inspection result 61 is outputted (step S360). For example, in a case where there is a record in which the second hash value 212 and the first hash value 152 do not match, a message indicating that an error has occurred in a page including this record is displayed on the display unit 523 of the computer 500 that functions as the variable PDF inspection device 20. When the inspection result 61 is outputted, the variable PDF file inspection processing ends.

Note that, as can be grasped from the above processing, in the present embodiment, the second hash value is calculated by the calculation rule of “calculating a hash value of a character string generated by combining data values of a plurality of fields as used fields in an arrangement order obtained by rearrangement using names of the fields as keys”. That is, the first hash value and the second hash value are calculated according to the same calculation rule. In the variable PDF file inspection processing, the above calculation rule is derived from the information 151 of the used fields.

### 1.4 Effects

According to the present embodiment, in the variable PDF generation device 10 that generates the variable PDF file 140 based on the variable data in the variable data file 110, the first hash value calculation processing of calculating the hash value (first hash value 152) according to a predetermined calculation rule using the variable data for the used fields which are fields used for variable printing among the fields included in the variable data file 110 is performed. In addition to the variable PDF file 140, the hash value file 150 including the information 151 of the used fields and the first hash value 152 for each of the plurality of records included in the variable data file 110 is transmitted from the variable PDF generation device 10 to the variable PDF inspection device 20. Note that data (data values of the plurality of fields as used fields) of a generation source of the first hash value 152 cannot be restored from the first hash value 152. In the variable PDF inspection device 20, for each of the plurality of records, the variable data for the used fields is extracted from the variable PDF file 140 based on the information 151 of the used fields and the layout information 1421, and the hash value (second hash value 212) is calculated using the extracted variable data according to the same calculation rule as the calculation rule when the first hash value 152 is calculated. Moreover, in the variable PDF inspection device 20, whether or not the second hash value 212 matches the first hash value 152 included in the hash value file 150 is inspected for each of the plurality of records.

Here, the variable data file 110 is not used for calculating the second hash value 212 in the variable PDF inspection device 20. That is, the personal information is not used for calculating the second hash value 212 in the variable PDF inspection device 20. Furthermore, the variable data file 110 is not required to inspect whether or not the second hash value 212 matches the first hash value 152. Thus, the variable data file 110 is not required for the processing performed by the variable PDF inspection device 20 to verify the validity of the content of each variable data included in the variable PDF file 140.

From the above, according to the present embodiment, the validity of the content of each variable data included in the variable PDF file 140 can be verified without using the personal information after the variable PDF file 140 is generated using the personal information.

### 2. Second Embodiment

A second embodiment of the present invention will be described. Hereinafter, differences from the first embodiment will be mainly described.

### 2.1 Configuration and the Like

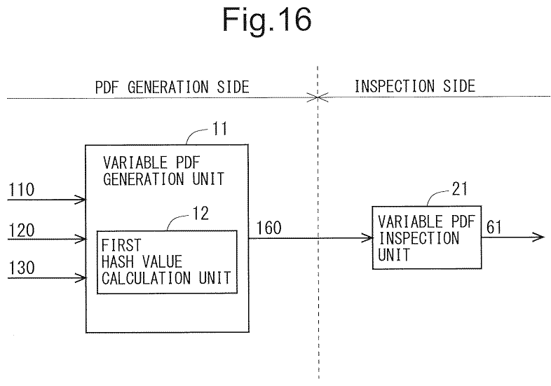

FIG. 16 is a diagram for explaining a functional configuration in the present embodiment. As illustrated in FIG. 16, in the present embodiment, the first hash value calculation unit 12 is included in the variable PDF generation unit 11. That is, in a computer 500 that functions as the variable PDF generation device 10, the hash value calculation program is executed by being called from the variable PDF file generation program. Since the PDF generation side is configured as described above, a variable PDF file 160 including information equivalent to the information included in the hash value file 150 according to the first embodiment is transmitted from the PDF generation side to the inspection side (from the variable PDF generation device 10 to the variable PDF inspection device 20).

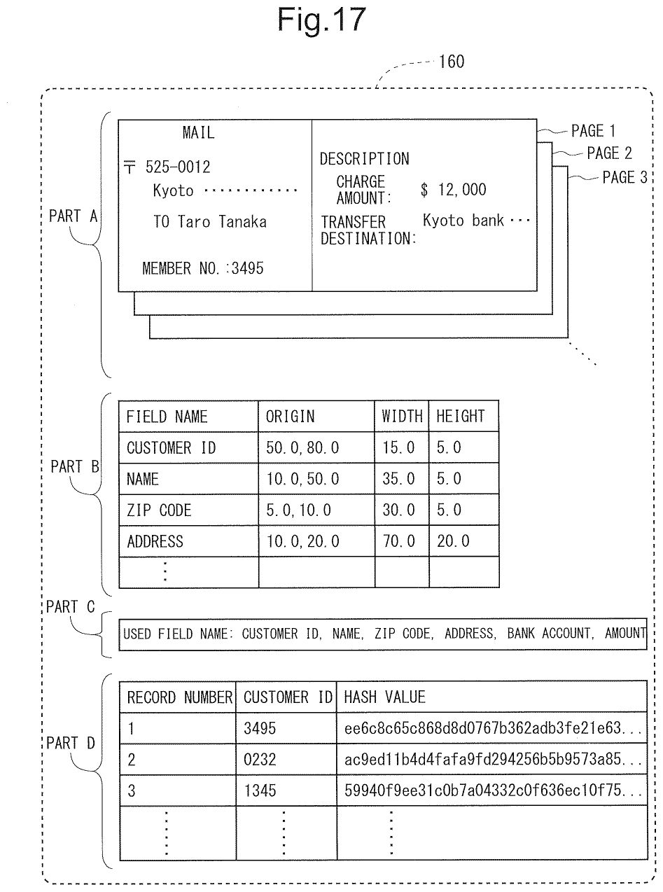

FIG. 17 is a diagram for explaining a configuration of the variable PDF file 160 in the present embodiment. The variable PDF file 160 includes actual data to be actually displayed or printed (see Part A), layout information (see Part B), information of used fields (see Part C), and information of a first hash value for each of a plurality of records (see Part D). The information of the used fields and the information of the first hash values are the information included in the hash value file 150 in the first embodiment. In the present embodiment, the layout information, the information of the used fields, and the information of the first hash values are included in the variable PDF file 160 as metadata.

### 2.2 Validity Verification Method of Print Data

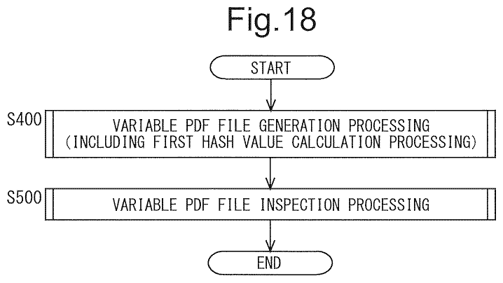

A schematic procedure of a series of processing related to the verification of the validity of the print data will be described with reference to a flowchart illustrated in FIG. 18. First, on the PDF generation side, the variable PDF generation unit 11 performs variable PDF file generation processing (step S400). In the present embodiment, the variable PDF file generation processing includes first hash value calculation processing performed by the first hash value calculation unit 12. In step S400, the variable PDF file 160 schematically illustrated in FIG. 17 is generated. After the variable PDF file 160 is transmitted from the PDF generation side to the inspection side, a variable PDF inspection unit 21 performs variable PDF file inspection processing on the inspection side (step S500).

From the above, also in the present embodiment, the first hash value calculation processing and the variable PDF file generation processing are executed on the PDF generation side, whereas the variable PDF file inspection processing is executed on the inspection side. That is, the variable PDF file inspection processing executed by a computer different from a computer that executes the first hash value calculation processing and the variable PDF file generation processing.

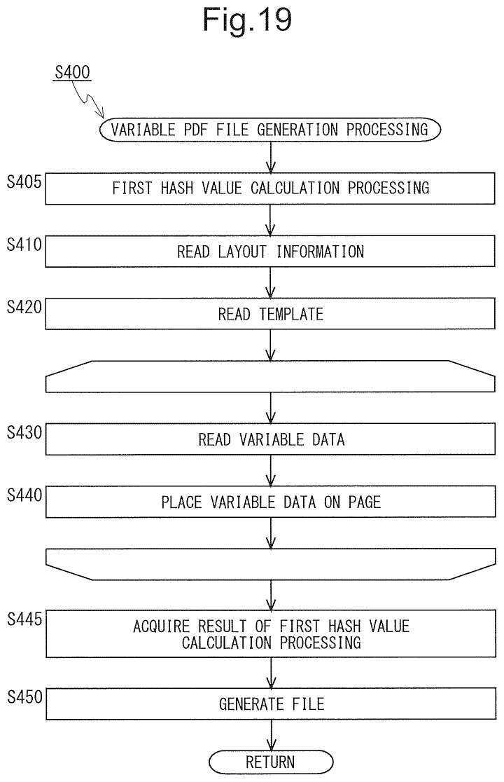

A detailed procedure of the variable PDF file generation processing according to the present embodiment will be described with reference to a flowchart illustrated in FIG. 19. After the variable PDF file generation processing is started, first, the hash value calculation program is called from the variable PDF file generation program. As a result, the first hash value calculation processing is performed (step S405). The first hash value calculation processing is performed similarly to the first embodiment (see FIG. 10). However, the processing of step S170 of FIG. 10 (the processing of generating the hash value file) is not performed. The processing of steps S410 to S440 is similar to the processing of steps S210 to S240 in the first embodiment (see FIG. 13). After the processing of steps S430 and S440 is ended for all of the plurality of records included in the variable data file 110, a result of the first hash value calculation processing is acquired (step S445). That is, in step S445, the information of the first hash value for each of the plurality of records included in the variable data file 110 is acquired. Thereafter, the variable PDF file 160 is generated by adding metadata to the actual data obtained by the processing in step S440 for the plurality of records included in the variable data file 110 (step S450). At that time, the layout information, the information of the used fields, and the information of the first hash values acquired in step S445 are included in the metadata.

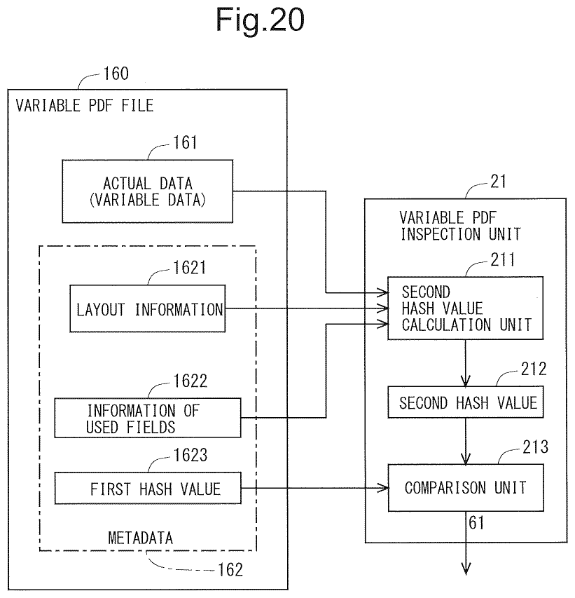

FIG. 20 is a block diagram for explaining details of the variable PDF inspection unit 21 that performs the variable PDF file inspection processing. The variable PDF file 160 includes actual data (variable data) 161, and metadata 162 including layout information 1621, information 1622 of used fields, and first hash values 1623. In the first embodiment, the variable PDF inspection unit 21 acquires the information 151 of the used fields and the first hash values 152 from the hash value file 150 (see FIG. 14). On the other hand, in the present embodiment, the variable PDF inspection unit 21 acquires the information 1622 of the used fields and the first hash values 1623 from the variable PDF file 160. Other points are similar to those of the first embodiment. That is, the detailed procedure of the variable PDF file inspection processing (processing of step S500 of FIG. 18) in the present embodiment is similar to that in the first embodiment (see FIG. 15).

### 2.3 Effects

According to the present embodiment, similarly to the first embodiment, the validity of content of each variable data included in the variable PDF file 160 can be verified without using the personal information after the variable PDF file 160 is generated using the personal information. Furthermore, although the variable PDF file 140 and the hash value file 150 are transmitted from the PDF generation side to the inspection side in the first embodiment, only the variable PDF file 160 is transmitted from the PDF generation side to the inspection side in the present embodiment. Thus, according to the present embodiment, since the number of files that need to be handled is small, the operation is easy as compared with the first embodiment.

### 3. Modifications

Hereinafter, modifications will be described.

### 3.1 First Modification

In each of the above embodiments, the hash value (first hash value and second hash value) is calculated from the character string obtained by combining the data values of the plurality of fields as used fields. On the other hand, in the present modification, a hash value is calculated from a character string obtained by combining data values of a plurality of fields as used fields and supplementary information such as coordinates of the plurality of fields.

In the present modification, at the time of generating the character string for calculating the first hash value (step S150 in FIG. 10), the data values of the plurality of fields as the used fields and the supplementary information such as the coordinates of the plurality of fields are combined in a predetermined order. Since the calculation of the second hash value and the calculation of the first hash value need to be performed according to the same calculation rule, information of a calculation rule for specifying how the first hash value is calculated using the variable data (data values of the plurality of fields) and the supplementary information is transmitted from the PDF generation side to the inspection side.

In the variable PDF file inspection processing, the data values of the plurality of fields and the supplementary information are combined in a predetermined order with reference to the information of the calculation rule transmitted from the PDF generation side to the inspection side, and a hash value of the character string obtained by the combination is calculated as the second hash value. Then, as in each of the above embodiments, for each record, whether or not the second hash value calculated in the variable PDF file inspection processing matches the first hash value transmitted from the PDF generation side to the inspection side is inspected.

### 3.2 Second Modification

In each of the above embodiments, the hash value (first hash value and second hash value) is calculated from the character string obtained by combining the data values of only the used fields. On the other hand, in the present modification, a hash value is calculated from a character string obtained by combining data values of used fields and one or more unused fields (fields not used for variable printing).

In the present modification, when the first hash value calculation processing is performed, variable data for the unused fields is extracted in addition to variable data for the used fields. Then, the first hash value is calculated using the extracted variable data (the variable data for the used fields and the variable data for the unused fields). Specifically, a hash value of a character string obtained by combining data values of a plurality of fields as used fields and data values of one or more fields as unused fields in a predetermined order is calculated as the first hash value.

Since the variable data for the unused fields is also required to calculate the second hash value, the variable data for the unused fields is included in the variable PDF file transmitted from the PDF generation side to the inspection side (that is, the variable PDF file transmitted from the variable PDF generation device 10 to the variable PDF inspection device 20). Furthermore, information of a calculation rule that specifies how the first hash value is calculated using the variable data for the used fields and the variable data for the unused fields is transmitted from the PDF generation side to the inspection side.

In the variable PDF file inspection processing, the second hash value is calculated using the variable data for the used fields and the variable data for the unused fields with reference to the information of the calculation rule transmitted from the PDF generation side to the inspection side. Then, as in each of the above embodiments, for each record, whether or not the second hash value calculated in the variable PDF file inspection processing matches the first hash value transmitted from the PDF generation side to the inspection side is inspected.

### 3.3 Third Modification

In each of the above embodiments, the hash value (first hash value and second hash value) is calculated from the character string obtained by combining the data values of the plurality of fields constituting each record. That is, the hash value is calculated for each record. In this case, when the first hash value and the second hash value do not match, it is not possible to identify a field where discrepancy in data value occurs. Therefore, in the present modification, a hash value is calculated for each field for each record. Hereinafter, a case where the present modification is applied to the first embodiment will be described.

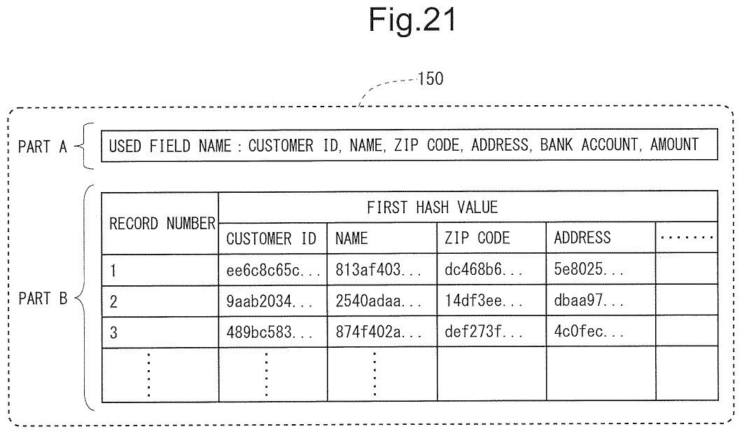

In the present modification, since the calculation of the hash value is performed for each field, processing of rearranging the plurality of fields as used fields (processing of step S130 in FIG. 10) and processing of generating the character string by combining the data values of the plurality of fields (processing of step S150 in FIG. 10) are unnecessary in the first hash value calculation processing. In step S160 of FIG. 10, a hash value (first hash value) is calculated for each of the plurality of data values (data values of the plurality of fields) acquired in step S140. That is, the first hash value is calculated for each field. Since the first hash value is calculated for each field in this manner, the contents of the hash value file 150 in the present modification are schematically as illustrated in FIG. 21. As illustrated in Part B of FIG. 21, in the hash value file 150, the first hash value is stored for each field for each record.

After the first hash value calculation processing and the variable PDF file generation processing are ended, the variable PDF file 140 schematically illustrated in FIG. 9 and the hash value file 150 schematically illustrated in FIG. 21 are transmitted from the PDF generation side to the inspection side.

Regarding the variable PDF file inspection processing, processing of generating the character string by combining the plurality of data values (processing of step S330 in FIG. 15) is unnecessary. In step S340 of FIG. 15, a hash value (second hash value) is calculated for each of the plurality of data values read in step S320. Then, in step S350 of FIG. 15, the second hash value calculated in step S340 is compared with the first hash value included in the hash value file 150 for each field. In other words, for a record to be processed, it is inspected whether or not the second hash value calculated in step S340 matches the first hash value included in the hash value file 150 for each field.

Meanwhile, in a case where there is a field in which the second hash value and the first hash value do not match, a message specifying a field in which the second hash value and the first hash value do not match may be displayed on the display unit 523 of the computer 500 that functions as the variable PDF inspection device 20. As a result, when there is a field in which the second hash value and the first hash value do not match, a user can easily identify a field where discrepancy in data value occurs. That is, when invalid data is included in the variable PDF file 140, the user can easily specify the invalid data.

### 3.4 Fourth Modification

In each of the above embodiments, it is assumed to verify the validity of the character data and the numerical data, and it is not assumed to verify the validity of image data. On the other hand, in the present modification, it is assumed that the validity of the image data is verified in addition to the character data and the numerical data.

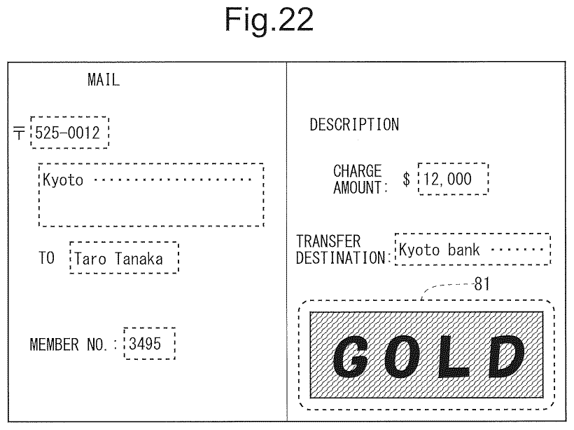

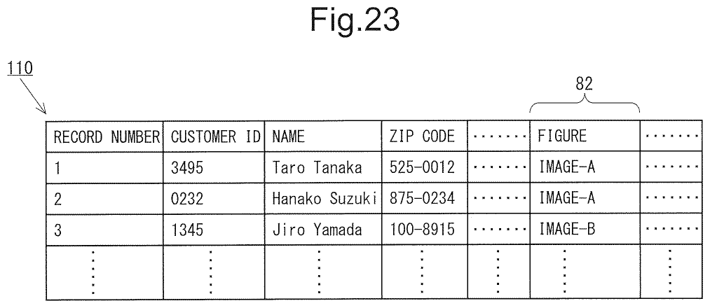

When printing is performed on the basis of the variable PDF file in the present modification, for example, a print result as illustrated in FIG. 22 is obtained as a print result for a certain record. An image is printed on a dotted line portion denoted by reference sign 81 in FIG. 22. Image data for printing such an image is stored in a predetermined folder. FIG. 23 is a diagram illustrating an example of the variable data file 110 according to the present modification. A file name of the image data is stored in a figure field 82 of the variable data file 110. That is, each record in the variable data file 110 and the image data stored in the predetermined folder are associated with each other by the file name stored in the figure field 82 of the variable data file 110.

Furthermore, in the present modification, in addition to a field for storing the character data and a field for storing the numerical data, the above-described figure field (that is, the field associated with the image data and storing the file name of the image data) can be set as a used field.

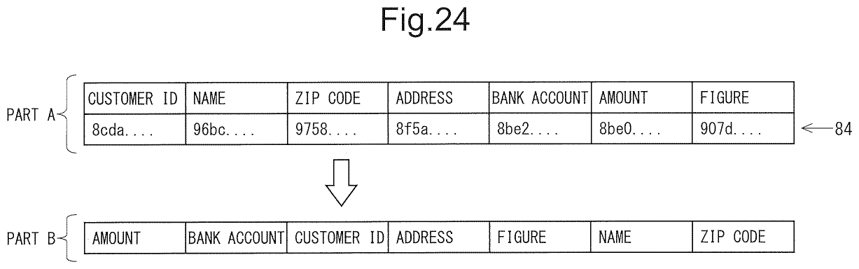

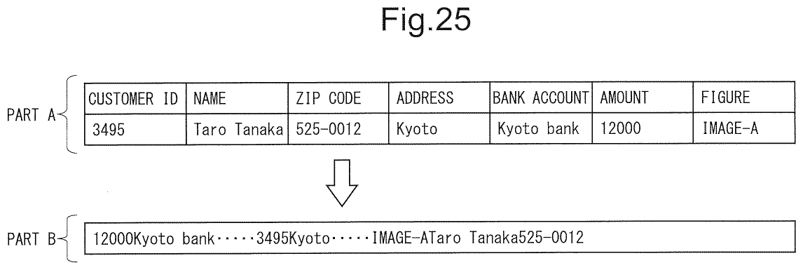

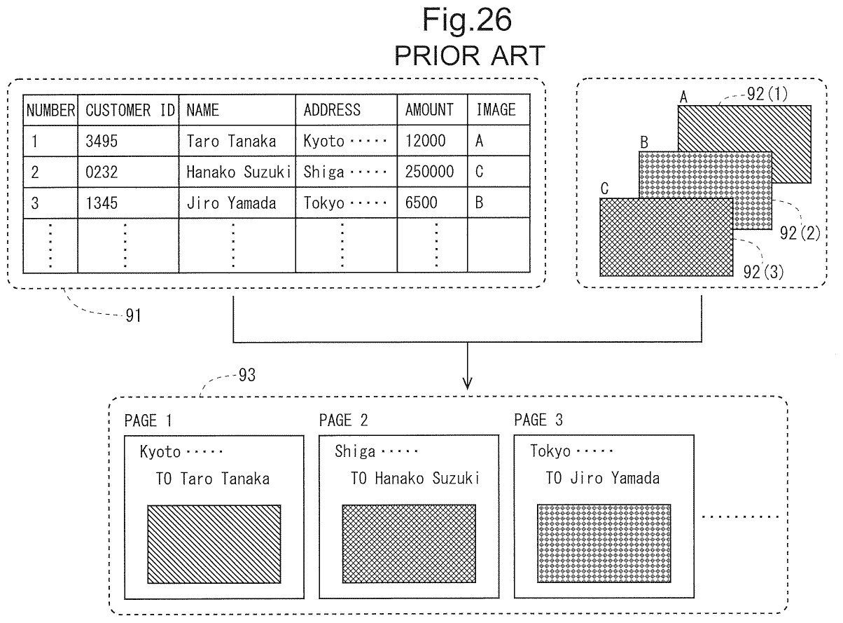

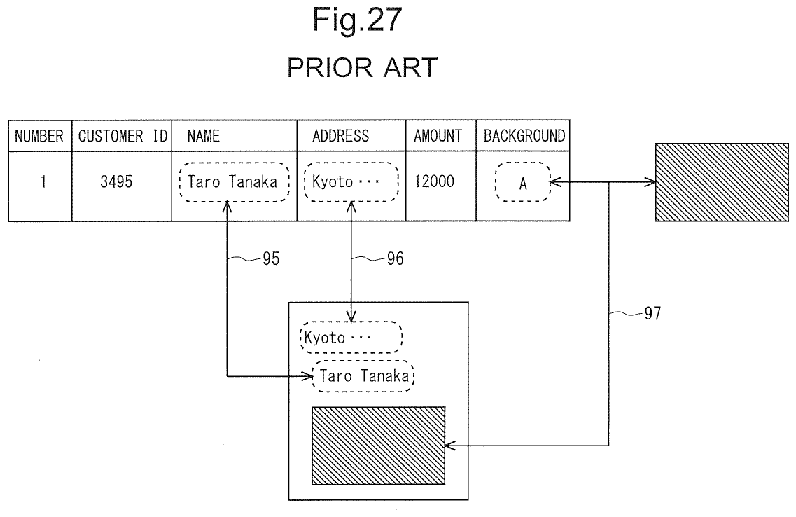

Under the above configuration, the above-described figure field is included in the used fields. As a result, in the first hash value calculation processing, in step S130 in FIG. 10, sorting of the used fields including the figure field are performed. Note that, in this regard, for example, assuming that the arrangement order of the used fields in the variable data file 110 is as illustrated in Part A of FIG. 24 and the predetermined character code of each field is as shown in a portion indicated by an arrow denoted by reference sign 84, the arrangement order of the used fields after sorting is as illustrated in Part B of FIG. 24. Furthermore, in step S150 of FIG. 10, the character string combination is performed including the data value of the figure field (in the present modification, a file name of image data). In this regard, for example, in a case where the data values of the plurality of fields as used fields with respect to the record to be processed are as illustrated in Part A of FIG. 25, a character string as illustrated in Part B of FIG. 25 is generated in step S150. Furthermore, in the variable PDF file generation processing, in step S240 of FIG. 13 and step S440 of FIG. 19, image data in addition to the character data and the numerical data is placed on the page on the basis of the template 130.

Since the file name of the image data is also required to calculate the second hash value, information of the file name of the image data placed on each page of the variable PDF file is transmitted from the PDF generation side to the inspection side (that is, from the variable PDF generation device 10 to the variable PDF inspection device 20).

Regarding the variable PDF file inspection processing, in step S320 of FIG. 15, the file name transmitted from the PDF generation side to the inspection side is acquired for the image. Then, in step S330 in FIG. 15, the character string combination is performed including the acquired file name. Accordingly, in step S340 of FIG. 15, the second hash value is calculated based on the character string similar to the character string of the calculation source of the first hash value. Then, as in each of the above embodiments, for each record, whether or not the second hash value calculated in the variable PDF file inspection processing matches the first hash value transmitted from the PDF generation side to the inspection side is inspected.

According to the present modification as above, regarding the contents of the variable PDF file, it is possible to verify the validity of the image data in addition to the validity of the character data and the numerical data without using personal information.

Note that, although the hash value of the character string obtained by the character string combination performed including the file name of the image data (the data value of the figure field) is calculated in the present modification, the configuration may be such that the hash value of RAW data of an image is calculated in addition to the hash value of the character string obtained by the character string combination using only the data values of the fields (that is, the fields for storing the character data and the fields for storing the numerical data) other than the figure field. In this case, the hash value of the character string and the hash value of the image (RAW data) are transmitted as the first hash value from the PDF generation side to the inspection side. Then, in the variable PDF file inspection processing, for each of the character string and the image, whether or not the second hash value calculated on the inspection side matches the first hash value transmitted from the PDF generation side to the inspection side is inspected.

### 3.5 Fifth Modification

Although the validity of the contents of the variable PDF file is verified using the hash value in each of the above embodiments, the present invention is not limited thereto. The validity of the contents of the variable PDF file can be verified using a checksum instead of the hash value. In this case, a first checksum is calculated (first checksum calculation processing is executed) on the PDF generation side, and the information 151 of the used fields and the first checksum for each of the plurality of records are included in the hash value file 150 transmitted from the PDF generation side to the inspection side. Furthermore, in the inspection side, a second checksum is calculated, and whether or not the second checksum matches the first checksum included in the hash value file 150 is inspected for each of the plurality of records.

### 4. Others

The present invention is not limited to the above embodiments (including the modifications), and various modifications can be made without departing from the gist of the present invention. For example, although the CSV file is adopted as the variable data file in each of the above embodiments, a file other than the CSV file can also be adopted as the variable data file. In this regard, for example, a TSV file that is a text data file in a format in which a plurality of pieces of text data is separated by tab symbols can be adopted as the variable data file. Furthermore, the variable data may be acquired not from the variable data file but from a database. Moreover, all fields constituting the variable data file 110 may be used fields, and unused fields may not be included in the variable data file 110.

Note that this application claims priority to Japanese Patent Application No. 2024-044891 titled “VALIDITY VERIFICATION METHOD FOR PRINT DATA AND PRINTING SYSTEM” filed on Mar. 21, 2024, the content of which is incorporated herein by reference.

What is claimed is:

1. A validity verification method of verifying, by using a computer, validity of data included in a print data file for executing variable printing based on variable data having a data value that can be different for each page and fixed data common to all pages, the validity verification method comprising:
performing first hash value calculation processing of, for each of a plurality of records, extracting the variable data for a used field that is a field used for variable printing from a variable data aggregate that stores the variable data, and calculating a first hash value according to a predetermined calculation rule by using extracted variable data;
performing print data file generation processing of placing, for each of the plurality of records, the variable data for the used field in the variable data aggregate on a corresponding page based on layout information in which a name of a field and coordinates are associated with each other, and generating the print data file including information of the variable data placed on each page; and
performing print data file inspection processing of, for each of the plurality of records, extracting the variable data from the print data file based on information of the used field and the layout information, calculating a second hash value according to the predetermined calculation rule by using extracted variable data, and inspecting whether or not the second hash value matches the first hash value,
wherein the print data file inspection processing is executed by a second computer different from a first computer that executes the first hash value calculation processing and the print data file generation processing.

2. The validity verification method according to claim 1, wherein in the first hash value calculation processing, a hash value file including the information of the used field and the first hash value for each of the plurality of records is generated,
in the print data file generation processing, the layout information is included in the print data file as metadata, and
the hash value file and the print data file are separately transmitted from the first computer to the second computer.

3. The validity verification method according to claim 1, wherein in the print data file generation processing, the layout information, the information of the used field, and the first hash value for each of the plurality of records calculated in the first hash value calculation processing are included in the print data file as metadata.

4. The validity verification method according to claim 1, wherein the information of the used field is transmitted from the first computer to the second computer, and
when the second hash value is calculated in the print data file inspection processing, the predetermined calculation rule is derived from the information of the used field.

5. The validity verification method according to claim 1, wherein a plurality of fields are set as the used field, and
the performing first hash value calculation processing includes:
reading the variable data in the variable data aggregate;
acquiring the information of the used field;
performing character string generation processing of generating a character string by combining, based on the information of the used field, the variable data for the plurality of fields in the variable data aggregate; and
calculating a hash value of the character string generated in the character string generation processing as the first hash value.

6. The validity verification method according to claim 5, wherein the performing first hash value calculation processing further includes performing rearrangement processing of rearranging the plurality of fields by using names of the plurality of fields as keys after the acquiring the information of the used field, and
in the character string generation processing, the variable data for the plurality of fields are combined in an order of the plurality of fields after being rearranged in the rearrangement processing.

7. The validity verification method according to claim 1, wherein in the first hash value calculation processing, the first hash value is calculated using the extracted variable data and coordinates associated with each field by the layout information.

8. The validity verification method according to claim 1, wherein in the first hash value calculation processing, the variable data for an unused field that is a field not used for variable printing is extracted in addition to the variable data for the used field, and the first hash value is calculated using the variable data for the used field and the variable data for the unused field,
in the print data file generation processing, the variable data for the unused field is included in the print data file, and
in the print data file inspection processing, the second hash value is calculated using the variable data for the used field extracted from the print data file and the variable data for the unused field extracted from the print data file.

9. The validity verification method according to claim 1, wherein in the first hash value calculation processing, the first hash value is calculated for each field, and
in the print data file inspection processing, the second hash value is calculated for each field, and whether or not the second hash value matches the first hash value is inspected for each field.

10. The validity verification method according to claim 9, wherein in a case where there is a field in which the second hash value and the first hash value do not match in the print data file inspection processing, the second computer outputs a message specifying a field in which the second hash value and the first hash value do not match.

11. The validity verification method according to claim 1, wherein a field that stores character data, a field that stores numerical data, and a field that is associated with image data and stores a file name of the image data are settable as the used field.

12. The validity verification method according to claim 1, wherein the print data file is a file in a portable document format.

13. The validity verification method according to claim 1, wherein the variable data aggregate is a text data file.

14. A validity verification method of verifying, by using a computer, validity of data included in a print data file for executing variable printing based on variable data having a data value that can be different for each page and fixed data common to all pages, the validity verification method comprising:
performing first checksum calculation processing of, for each of a plurality of records, extracting the variable data for a used field that is a field used for variable printing from a variable data aggregate that stores the variable data, and calculating a first checksum according to a predetermined calculation rule by using extracted variable data;
performing print data file generation processing of placing, for each of the plurality of records, the variable data for the used field in the variable data aggregate on a corresponding page based on layout information in which a name of a field and coordinates are associated with each other, and generating the print data file including information of the variable data placed on each page; and
performing print data file inspection processing of, for each of the plurality of records, extracting the variable data from the print data file based on information of the used field and the layout information, calculating a second checksum according to the predetermined calculation rule by using extracted variable data, and inspecting whether or not the second checksum matches the first checksum,
wherein the print data file inspection processing is executed by a second computer different from a first computer that executes the first checksum calculation processing and the print data file generation processing.

15. A printing system capable of executing variable printing based on variable data having a data value that can be different for each page and fixed data common to all pages, the printing system comprising:
a first computer that performs first hash value calculation processing of, for each of a plurality of records, extracting the variable data for a used field that is a field used for variable printing from a variable data aggregate that stores the variable data, and calculating a first hash value according to a predetermined calculation rule by using extracted variable data, and print data file generation processing of placing, for each of the plurality of records, the variable data for the used field in the variable data aggregate on a corresponding page based on layout information in which a name of a field and coordinates are associated with each other, and generating print data file including information of the variable data placed on each page; and
a second computer that performs print data file inspection processing of, for each of the plurality of records, extracting the variable data from the print data file based on information of the used field and the layout information, calculating a second hash value according to the predetermined calculation rule by using extracted variable data, and inspecting whether or not the second hash value matches the first hash value.
